(19) United States
(12) Patent Application Publication
(10) Pub. No.: US 2018/0306030 A1
(43) Pub. Date: Oct. 25, 2018

(54) METHOD FOR IMPROVING RESERVOIR PERFORMANCE BY USING DATA SCIENCE

(71) Applicant: Landmark Graphics Corporation, Houston, TX (US)

(72) Inventor: Satyam Priyadarshy, Katy, TX (US)

(21) Appl. No.: 15/769,306

(22) PCT Filed: Dec. 22, 2015
(86) PCT No.: PCT/US2015/067508

§ 371 Date: Apr. 18, 2018

(51) Int. Cl. E21B 49/00; G06F 17/50; G01V 1/50

(52) U.S. Cl. CPC E21B 49/005; G01V 2210/612; G01V 1/50; G06F 17/5009

(57) ABSTRACT

In accordance with presently disclosed embodiments, systems and methods for generating a reservoir fluid flow simulation are disclosed. The method includes: obtaining prior reservoir fluid flow simulations generated for the reservoir and a plurality of associated input attributes used to generate the prior simulations; analyzing a variability of the input attributes among the prior reservoir fluid flow simulations; obtaining actual reservoir performance data and associated fluid flow attributes over time; analyzing a variability of the fluid flow attributes; and comparing the variability of the input attributes generated using the prior simulations to the corresponding fluid flow attributes from the actual reservoir performance data.

### TECHNICAL FIELD

The present disclosure relates generally to systems and methods of determining oil field reservoir performance, and more particularly to a method of improving reservoir performance by analyzing reservoir simulations by exploiting data science.

### BACKGROUND

Historically, most oil and gas reservoirs have been developed and managed under timetables and scenarios as follows: a preliminary investigation of a subterranean surface believed to contain hydrocarbons is conducted using broad geological methods for collection and analysis of data such as seismic, gravimetric, and magnetic data, to determine regional geology and subsurface reservoir structure. In some instances, more detailed seismic mapping of a specific structure is conducted in an effort to reduce the high cost, and the high risk, of an exploration well. A test well is then drilled to penetrate the identified structure to confirm the presence of hydrocarbons, and to test productivity. In lower-cost onshore areas, development of a field will then commence immediately by completing the test well as a production well. In higher cost or more hostile environments such as the North Sea and other offshore locations, a period of appraisal will follow, leading to a decision as to whether or not to develop the project. In either case, based on inevitably sparse data, further development wells, both producers and injectors will be planned in accordance with a reservoir development plan. Once production and/or injection begins, more dynamic data will become available, thus, allowing the engineers and geoscientists to better understand how the reservoir rock is distributed and how the fluids are flowing. As more data becomes available, an improved understanding of the reservoir is used to adjust the reservoir development plan resulting in the familiar pattern of recompletion, sidetracks, infill drilling, well abandonment, etc. Unfortunately, not until the time at which the field may become abandoned, and when the information is the least useful, does reservoir understanding generally reach its maximum.

Limited and relatively poor quality of reservoir data throughout the life of the reservoir, coupled with the relatively high cost of most types of well intervention, implies that reservoir management is as much an art as a science. Engineers and geoscientists responsible for reservoir management discuss injection water, fingering, oil-water contacts rising, and fluids moving as if these are a precise process. The reality, however, is that water expected to take three years to break through to a producing well might arrive in six months in one reservoir but might never appear in another. Text book “piston like” displacement rarely happens, and one could only guess at flood patterns.

For some time, reservoir engineers and geoscientists have made assessments of reservoir attributes and optimized production using downhole test data taken at selected intervals. Such data usually includes traditional pressure, temperature and flow data is well known in the art. Reservoir engineers have also had access to production data for the individual wells in a reservoir. Such data as oil, water and gas flow rates are generally obtained by selectively testing production from the selected well at selected intervals.

Recent improvements in the state of the art regarding data gathering, both down hole and at the surface, have dramatically increased the quantity and quality of data gathered. Examples of such state of the art improvements in data acquisition technology include assemblies run in the casing string comprising a sensor probe with optional flow ports that allow fluid inflow from the formation into the casing while sensing wellbore and/or reservoir attributes as described and disclosed in international PCT application WO. 97/49894, assigned to Baker Hughes. The casing assembly may further include a microprocessor, a transmitting device, and a controlling device located in the casing string for processing and transmitting data. A memory device may also be provided for recording data relating to the monitored wellbore or reservoir attributes. Examples of downhole attributes which may be monitored with such equipment include: porosity, pressure, permeability, geological format, temperature, fluid flow rate and type, formation resistivity, cross-well and acoustic seismometry, perforation depth, fluid attributes and logging data. Using a microprocessor, hydrocarbon production performance may be enhanced by activating local operations in additional downhole equipment. A similar type of casing assembly used for gathering data is described and illustrated in international PCT application WO 98/12417, assigned to BP Exploration Operating Company Limited.

Recent technology improvements in downhole flow control devices are disclosed in UK Patent Application GB 2,320,731A, which describes a number of downhole flow control devices, which may be used to shut off particular zones by using downhole electronics and programming with decision making capacity.

Another important emerging technology that may have a substantial impact on managing reservoirs is time lapsed seismic, often referred to a 4-D seismic processing. In the past, seismic surveys were conducted only for exploration purposes. However, incremental differences in seismic data gathered over time are becoming useful as a reservoir management tool to potentially detect dynamic reservoir fluid movement. This is accomplished by removing the non-time varying geologic seismic elements to produce a direct image of the time-varying changes caused by fluid flow in the reservoir. By using 4-D seismic processing, reservoir engineers can locate bypassed oil to optimize infill drilling and flood pattern. Additionally, 4-D seismic processing can be used to enhance the reservoir model and history match flow simulations.

International PCT application WO 98/07049, assigned to Geo-Services describes and discloses state of the art seismic technology applicable for gathering data relevant to a producing reservoir. The publication discloses a reservoir monitoring system comprising: a plurality of permanently coupled remote sensor nodes, wherein each node comprises a plurality of seismic sensors and a digitizer for analog signals; a concentrator of signals received from the plurality of permanently coupled remote sensor nodes; a plurality of remote transmission lines which independently connect each of the plurality of remote sensor nodes to the concentrator, a recorder of the concentrated signals from the concentrator, and a transmission line which connects the concentrator to the recorder. The system is used to transmit remote data signals independently from each node of the plurality of permanently coupled remote sensor nodes to a concentrator and then transmit the concentrated data signals to a recorder. Such advanced systems of gathering seismic data may be used in the reservoir management system of the present disclosure as disclosed hereinafter in the Detailed Description section of the application.

Historically, downhole data and surface production data has been analyzed by pressure transient and production analysis. Presently, a number of commercially available computer programs such as Saphir and PTA are available to do such an analysis. The pressure transient analysis generates output data well known in the art, such as permeability-feet, skin, average reservoir pressure and the estimated reservoir boundaries. Such reservoir parameters may be used in the reservoir management system of the present disclosure.

In the past and present, geoscientists, geologists and geophysicists (sometimes in conjunction with reservoir engineers) analyzed well log data, core data and SDL data. The data was and may currently be processed in log processing/interpretation programs that are commercially available, such as Petroworks and DPP. Seismic data may be processed in programs such as Seisworks and then the log data and seismic data are processed together and geostatistics applied to create a geocellular model.

Presently, reservoir engineers may use reservoir simulators such as VIP or Eclipse to analyze the reservoir. Nodal analysis programs such as WEM, Prosper and Openflow have been-used in conjunction with material balance programs and economic analysis programs such as Aries and ResEV to generate a desired field wide production forecast. Once the field wide production has been forecasted, selected wells may be produced at selected rates to obtain the selected forecast rate. Likewise, such analysis is used to determine field wide injection rates for maintenance of reservoir pressure and for water flood pattern development. In a similar manner, target injection rates and zonal profiles are determined to obtain the field wide injection rates.

It is estimated that between fifty and seventy percent of a reservoir engineer's time is spent manipulating data for use by each of the computer programs in order for the data gathered and processed by the disparate programs (developed by different companies) to obtain a resultant output desired field wide production forecast. Due to the complexity and time required to perform these functions, frequently an abbreviated incomplete analysis is performed with the output used to adjust a surface choke or recomplete a well for better reservoir performance without knowledge of how such adjustment will affect reservoir management as a whole.

Furthermore, with respect the reservoir simulations piece of reservoir management to which the present disclosure is focused, current reservoir simulations are computationally intensive. Also, they rely heavily on fitting the attributes empirically to the performance data, through a process called history matching. It is desired to employ more accurate simulations that take away the empirical assumptions employed with existing simulations and which are more robust and which reduce the cost of performing multiple simulations.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a production graph showing a plurality of sample reservoir simulations and how they compare to actual performance graphs;

FIG. 2 is a representational drawing showing the stacking of all the previous reservoir simulations for a given reservoir in accordance with the present disclosure;

FIG. 3 is a flow chart illustrating the process flow of the reservoir simulation method in accordance with the present disclosure; and

FIG. 4 is graph illustrating reservoir attributes and parameters as data sets resulting from simulations at certain points in time along the production history.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

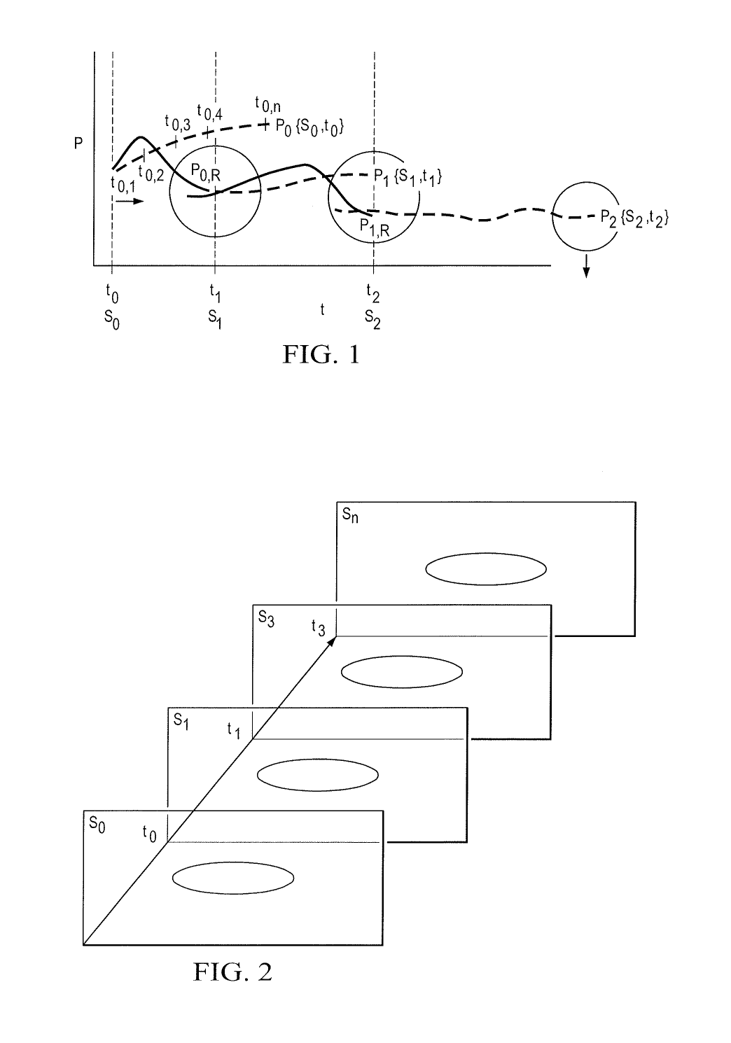

In conventional reservoir simulation science, production flow rates are simulated and compared to actual production flow data. FIG. 1 shows a graph of a representative plurality of simulated production rate curves plotted against an associated plurality of actual production flow curves. The first simulated production rate curve P₀ is represented by the set {S₀, t₀}, where S₀ is the simulation at time t₀. It is the simulation of production flow rate that is generated at time t₀. Theoretically, the simulation can be taken out until an infinite time in the future. In reality, the simulation is cut off at a point in time when the next simulation is generated, which may be 1-2 years later. In this case, the new simulation may be generated say, e.g., between intervals t_{0,3} and t_{0,4}. The actual production rate that occurs from time t₀ onward through the timeframe that the first simulation is being used is indicated by curve P_{0R}. As can be seen, the actual production varies a fair bit from the simulated production rate curve P₀, especially the further out in time from when the initial simulation was generated. At time t₁, the new simulation curve is generated. It is identified as P₁ and represented by the set {S₁, t₁}, where S₁ is the simulation at time t₁. The actual production rate curve that occurs during this second time frame is indicated by the curve P_{1R}. Once again, there is a deviation between the two curves, with the greatest deviation occurring further out in time from when the second simulation was generated. A third simulation curve is generated P₂, which is represented by set {S₂, t₂}, where S₂ is the simulation at time t₂. Once again, the corresponding actual production curve designed by P_{2R} deviates from the simulated production curve P₃.

Using only conventional techniques, subsequent simulations are generated using a technique known as history matching. History matching is a technique which attempts to compare how the predicted production flow performed against the actual production flow and then use the data generated from that comparison to refine the simulation. Typically, the history matching is only done over a shortened interval of time that the previous simulation took place, e.g., 6 months out of a 2-year period. Furthermore, the history matching technique only looks back at the historical information gathered during the immediately preceding simulation time period. It does not look back any further.

The method of the present disclosure employs an entirely new approach in generating reservoir simulations for use in the prediction and management of production flow from one or more producing wells in a field drawing from the reservoir. The method of the present disclosure takes into account all of the previous simulations generated for the reservoir since the reservoir has been producing. This concept at a high level stacks the previous simulations and employs them into each of the successive simulations. This is broadly represented by the stacked simulations, shown in FIG. 2.

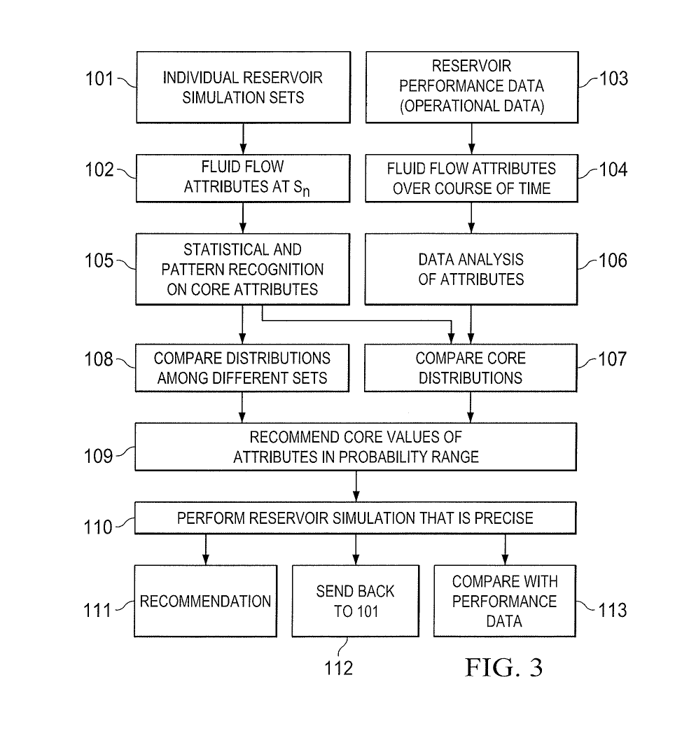

More specifically, the novel method according to the present disclosure is shown in the representative flow chart shown in FIG. 3. In one series of steps (101, 102 and 103), the historical simulation data is gathered and analyzed. In step 101, the individual historical simulations are gathered and stored {S₀, S₁, S₂, S₃, . . . Sₙ}, for example in a memory of a computer having a processor (not shown). In step 102, the predicted values of the core attributes that effect fluid flow, which were used in generating the historical simulations are extracted and stored in the memory. These attributes include, e.g., porosity (ϕ), pressure (P), permeability (Pe) and geological format (gf). As those of ordinary skill in the art will appreciate, these attributes are just representative. Additional or other attributes may be utilized. A statistical and pattern recognition analysis is performed on the core attributes in step 105.

In a separate but parallel series of steps (103, 104 106), the actual production flow data is gathered and analyzed. In step 103, the actual reservoir performance data over the corresponding intervals of the historical simulations {S₀, S₁, S₂, S₃, . . . Sₙ} are gathered and stored in memory. In step 104, the fluid flow attributes of the reservoir over those same time intervals are extracted and stored in memory. Exemplary fluid flow attributes include, but are not limited to, density, compressibility, viscosity and other similar properties. In step 106, the fluid flow attribution data is analyzed.

The various data sets are then compared. In step 107, the statistical and pattern recognition data relating to the core predicted attributes are compared to the data analysis of the fluid flow attributes extracted from the actual production data. This comparative step is the history matching step. In step 108, the distribution among the different sets of simulation data is compared and analyzed. The history matching data and comparative analysis of the prior simulations are then used to determine or recommend the values of the attributes in the next simulation to be generated. The values are selected within a probability range. This is done in step 109. This information is then used to derive a new reservoir simulation that is precise. This is done in step 110. The new reservoir simulation is represented by the following formula:

Sₙ=f(R_{c1},Pₙ,Hₙ)+contribution of {S₀,S₁,S₂,S₃, . . . Sₙ₋₁}

where,

Sₙ is the reservoir simulation at time n;

f is a best fit function applied to the variable, R_{c1}, Pₙ, Hₙ;

R_{c1} are the reservoir attributes, e.g., porosity, permeability, etc.;

Pₙ are the parameters, e.g., gas production rate, oil production rate, water production rate, productivity index, water cut, pressure at time n, etc.;

Hₙ is the history matching at time n; and

S₀, S₁, S₂, S₃, . . . Sₙ₋₁ are the prior simulations at times t₁, t₂, t₃, to time n−1.

The contribution of the prior simulations never before has been factored into the generation of the simulations. By looking back at the previous simulations, the reservoir engineer is able to see how the changes in porosity, permeability and other reservoir attributes vary over time. By factoring this into the next simulation (Sₙ), that leads to a more accurate simulation, which in turn leads to a reduction in the number of simulations needed in the future, which ultimately reduces the overall cost of the reservoir simulation, but more importantly leads to better reservoir prediction and thus management.

Once the reservoir simulation Sₙ using the above approach is generated, recommendations concerning how production may be altered may be generated. An example of such alteration may include, but not be limited to, modifying the injection rates in existing injection wells, adding new injection wells, performing additional stimulation steps and/or fracturing techniques. These recommendations are made in step 111. After a period of time n+1, the process may then be repeated. This occurs in step 112. Alternatively, or in addition to step 112, the production performance of simulation (Sₙ), may be compared to actual performance data either at time n+1 or in real time. This is done in step 113.

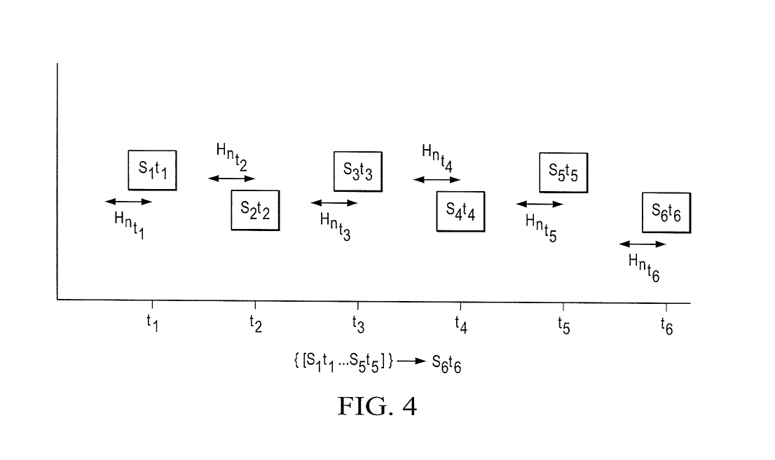

At an instant when the reservoir simulation is performed using history matching and other methods, a set of attributes are modified and a set of parameters are obtained to match the production parameters. This process contains a significant knowledge about the underlying mechanisms of reservoir characterization. In FIG. 4, these attributes and parameters obtained are considered as data sets as a result of simulations S₀, S₁ . . . Sₙ performed at times t₀, t₁ . . . tₙ; that brings new dimension for obtaining a robust set of attributes that can be exploited for further optimization of the production parameters.

A method of generating a reservoir fluid flow simulation is provided, which comprises obtaining prior reservoir fluid flow simulations generated for the reservoir and a plurality of associated input attributes used to generate the prior simulations; analyzing a variability of the input attributes among the prior reservoir fluid flow simulations; obtaining actual reservoir performance data and associated fluid flow attributes over time; analyzing a variability of the fluid flow attributes; and comparing the variability of the input attributes generated using the prior simulations to the corresponding fluid flow attributes from the actual reservoir performance data. In any of the embodiments described in this paragraph, analyzing the variability of the input attributes among the prior reservoir fluid flow simulations may comprise performing a plurality of pattern recognition techniques to generate a landscape of variability of the input attributes. In any of the embodiments described in this paragraph, the method may further comprise comparing through statistical analysis the variability of the input attributes. In any of the embodiments described in this paragraph, the method may further comprise performing a plurality of engine algorithms to determine best values within certain probabilities of the input attributes. In any of the embodiments described in this paragraph, the method may further comprise generating a heat map of the reservoir illustrating the probabilistic prediction of production performance. In any of the embodiments described in this paragraph, the method may further comprise monitoring the performance of one or more wells in the reservoir by comparing the actual well performance data to the obtained input attributes.

A method of reservoir fluid flow simulation is also provided, which comprises obtaining a plurality of prior simulations for the reservoir for certain discrete time periods; obtaining actual performance data for the reservoir during the certain discrete time periods; generating a new simulation for the reservoir as a function of the plurality of prior simulations for the reservoir and the actual performance data. In any of the embodiments described in this or the preceding paragraph, the method may further comprise obtaining a plurality of associated input attributes used to generate the prior simulations; analyzing a variability of the input attributes among the prior reservoir fluid flow simulations; obtaining associated fluid flow attributes of the reservoir from the actual reservoir performance data; analyzing a variability of the fluid flow attributes; and comparing the variability of the input attributes generated using the prior simulations to the corresponding fluid flow attributes from the actual reservoir performance data. In any of the embodiments described in this or the preceding paragraph, analyzing the variability of the input attributes among the prior reservoir fluid flow simulations may comprise performing a plurality of pattern recognition techniques to generate a landscape of variability of the input attributes. In any of the embodiments described in this or the preceding paragraph, the method may further comprise comparing through statistical analysis the variability of the input attributes. In any of the embodiments described in this or the preceding paragraph, the method may further comprise performing a plurality of engine algorithms to determine best values within certain probabilities of the input attributes. In any of the embodiments described in this or the preceding paragraph, the method may further comprise generating a heat map of the reservoir illustrating the probabilistic prediction of production performance. In any of the embodiments described in this or the preceding paragraph, the method may further comprise recommending one or more downhole operations based on the variability in the input attributes. In any of the embodiments described in this or the preceding paragraph, the method may further comprise monitoring the performance of one or more wells in the reservoir by comparing the actual well performance data to the obtained input attributes.

A method of reservoir fluid flow simulation is also provided, which comprises generating a new simulation for the reservoir based on one or more reservoir attributes, one or more reservoir parameters, history matching of reservoir performance data and a plurality of prior reservoir simulations. In any of the embodiments described in this or the preceding two paragraphs, a best fit function may be applied to the one or more reservoir attributes, one or more reservoir parameters, and history matching. In any of the embodiments described in this or the preceding two paragraphs, the one or more reservoir attributes may comprise porosity, permeability, pressure, and geological formation. In any of the embodiments described in this or the preceding two paragraphs, the one or more parameters may include gas production rate, oil production rate, water production rate, productivity index, water cut, pressure, etc. In any of the embodiments described in this or the preceding two paragraphs, the history matching may comprise fitting reservoir attributes empirically to performance data.

Although the present disclosure and its advantages have been described in detail, it should be understood that various changes, substitutions and alterations can be made herein without departing from the spirit and scope of the disclosure as defined by the following claims.

What is claimed is:

1. A method of generating a reservoir fluid flow simulation, comprising:
obtaining prior reservoir fluid flow simulations generated for the reservoir and a plurality of associated input attributes used to generate the prior simulations;
analyzing a variability of the input attributes among the prior reservoir fluid flow simulations;
obtaining actual reservoir performance data and associated fluid flow attributes over time;
analyzing a variability of the fluid flow attributes; and
comparing the variability of the input attributes generated using the prior simulations to the corresponding fluid flow attributes from the actual reservoir performance data.

2. The method of claim 1, wherein analyzing the variability of the input attributes among the prior reservoir fluid flow simulations comprises performing a plurality of pattern recognition techniques to generate a landscape of variability of the input attributes.

3. The method of claim 1, further comprising comparing through statistical analysis the variability of the input attributes.

4. The method of claim 1, further comprising performing a plurality of engine algorithms to determine best values within certain probabilities of the input attributes.

5. The method of claim 1, further comprising generating a heat map of the reservoir illustrating the probabilistic prediction of production performance.

6. The method of claim 1, further comprising monitoring the performance of one or more wells in the reservoir by comparing the actual well performance data to the obtained input attributes.

7. A method of reservoir fluid flow simulation, comprising:
obtaining a plurality of prior simulations for the reservoir for certain discrete time periods;
obtaining actual performance data for the reservoir during the certain discrete time periods;
generating a new simulation for the reservoir as a function of the plurality of prior simulations for the reservoir and the actual performance data.

8. The method of claim 7, further comprising:
obtaining a plurality of associated input attributes used to generate the prior simulations;
analyzing a variability of the input attributes among the prior reservoir fluid flow simulations;
obtaining associated fluid flow attributes of the reservoir from the actual reservoir performance data;
analyzing a variability of the fluid flow attributes; and
comparing the variability of the input attributes generated using the prior simulations to the corresponding fluid flow attributes from the actual reservoir performance data.

9. The method of claim 8, wherein analyzing the variability of the input attributes among the prior reservoir fluid flow simulations comprises performing a plurality of pattern recognition techniques to generate a landscape of variability of the input attributes.

10. The method of claim 8, further comprising comparing through statistical analysis the variability of the input attributes.

11. The method of claim 8, further comprising performing a plurality of engine algorithms to determine best values within certain probabilities of the input attributes.

12. The method of claim 8, further comprising generating a heat map of the reservoir illustrating the probabilistic prediction of production performance.

13. The method of claim 8, further comprising recommending one or more downhole operations based on the variability in the input attributes.

14. The method of claim 8, further comprising monitoring the performance of one or more wells in the reservoir by comparing the actual well performance data to the obtained input attributes.

15. A method of reservoir fluid flow simulation, comprising:
generating a new simulation for the reservoir based on one or more reservoir attributes, one or more reservoir parameters, history matching of reservoir performance data and a plurality of prior reservoir simulations.

16. The method of claim 15, wherein a best fit function is applied to the one or more reservoir attributes, one or more reservoir parameters, and history matching.

17. The method of claim 15, wherein the one or more reservoir attributes comprise porosity, permeability, pressure, and geological formation.

18. The method of claim 15, wherein the one or more parameters include gas production rate, oil production rate, water production rate, productivity index, water cut, and pressure.

19. The method of claim 15, wherein the history matching comprises fitting reservoir attributes empirically to performance data.
